(19) United States
(12) Patent Application Publication
(10) Pub. No.: US 2012/0003468 A1
(43) Pub. Date: Jan. 5, 2012

(54) Stretched Thermoplastic Resin for Gluing Metal Parts to Plastics, Glass and Metals, and Method for the Production Thereof

(76) Inventors: Marc Husemann, Hamburg (DE); Matthias Koop, Norderstedt (DE)

(21) Appl. No.: 12/996,960

(22) PCT Filed: Aug. 26, 2009
(86) PCT No.: PCT/EP09/60964

§ 371 Date: Feb. 1, 2011

(30) Foreign Application Priority Data
Dec. 5, 2008 (DE) 10 2008 060 415.1
Mar. 26, 2009 (DE) 10 2009 014 387.4

(51) Int. Cl. B32B 7/12; B29C 47/14; B32B 37/14; B32B 38/10; B32B 37/12; B32B 37/06

(52) U.S. Cl. 428/343; 156/60; 156/247; 264/177.19

(57) ABSTRACT

A method produces stretched, 2-dimensional adhesives based on heat-activatable thermoplastic resins. The stretched adhesives are usable for gluing metal parts to plastics for portable consumer electronics articles. The stretched adhesives are usable as specialized thermoplastic heat-activatable films for fastening metal parts onto plastic parts. By using and applying the specially treated thermoplastic resins, processing and the properties of adhesion are improved.

This is a 371 of PCT/EP2009/060964 filed 26 Aug. 2009 (international filing date), and claims the priority of German Application No. 10 2008 060 415.1, filed 5 Dec. 2008, and German Application No. 10 2009 014 387.4, filed 26 Mar. 2009.

The invention relates to processes for producing stretched, sheet-like adhesives based on heat-activatable thermoplastics, and also to corresponding stretched adhesives, and also to use thereof for the adhesive bonding of metal parts on plastics for portable consumer-electronics items. In the invention, the use is based on the utilization of specific thermoplastic heat-activatable foils for fixing the metal parts on the plastics parts. The use and the insertion of the specifically treated thermoplastics improves the processing and also the properties of the adhesive bond.

Double-sided pressure-sensitive adhesive tapes are usually used for adhesive bonding of metal parts on plastics. The adhesive strengths required here are sufficient for fixing and fastening of the metal components on the plastics. Metals used preferably comprise stainless steel, or else chromed steel or other types of steel. Examples of plastics used are PVC, ABS, PC, PPA, PA, or blends based on said plastics. However, the requirements placed upon portable consumer-electronics items are constantly becoming more stringent. Firstly, said items are constantly becoming smaller, and the adhesive-bonding areas are therefore also becoming smaller. Secondly, the adhesive bond must comply with additional requirements since portable items are used within a relatively large temperature range and moreover can have exposure to mechanical loads, such as impacts, falls, etc. These preconditions are particularly problematic for adhesive bonds of metal on plastics. During a fall, the plastic can absorb some of the energy, whereas metals do not deform at all. The adhesive tape here must absorb a large proportion of the energy. This can be achieved in a particularly efficient manner via the use of heat-activatable foils which, after activation, can develop particularly high adhesive strength. Another problem is the different expansion coefficients of the metals and plastics. These can produce stresses between the plastics components and metal components in the event of rapid temperature changes.

Heat-activatable adhesive masses can be subdivided into two categories:

a) thermoplastic, heat-activatable foils and b) reactive, heat-activatable foils.

However, the known thermoplastic systems also have disadvantages. In order to achieve high shock resistance, for example when a mobile telephone falls to the floor, relatively soft and elastic thermoplastics are used for adhesive bonding. However, this is also attended by disadvantages. The softness makes it difficult to carry out a punching process on the thermoplastics. Another disadvantage of the materials, which are mostly thermoplastic copolyesters or copolyamides, is that they absorb a relatively large amount of moisture. This always creates disadvantages during adhesive bonding, an example being blistering, which weakens the adhesive bond. There is another disadvantage of the thermoplastics which likewise becomes apparent during the adhesive-bonding process. The shape of the heat-activatable foil has a relatively severe tendency toward displacement-under-pressure in the hot-adhesive-bonding step, since viscosity falls markedly during heating and heat-activation.

There is therefore a requirement to improve this behavior of heat-activatable foils. In particular, there is a requirement for a thermoplastic, heat-activatable adhesive, in particular in the form of a foil which does not have the abovementioned disadvantages, or mitigates the existing problems. There is moreover a requirement for a process for producing correspondingly improved thermoplastic adhesives.

In the light of said prior art, the invention is based on the object of providing a thermoplastic heat-activatable foil which can be used for the adhesive-bonding process and which has less tendency to displace under pressure during the adhesive-bonding process, and which has less susceptibility to water-absorption during storage or in stored form prior to adhesive bonding, so that blistering in the adhesive joint can be reduced and/or eliminated during the hot-adhesive-bonding process.

The invention achieves the object via a process with the following steps:

a) extrusion or extrusion-coating of a heat-activatable thermoplastic

b) stretching of the heat-activatable thermoplastic film in machine direction by a factor of at least 3, where the stretching temperature is preferably at least 30% below the extrusion temperature, and the enthalpy of fusion of the stretched thermoplastic adhesive is at least 30% above the enthalpy of fusion of the unstretched state of the adhesive, in particular of the thermoplastic

c) application of the oriented heat-activatable thermoplastic film to a backing.

The invention provides a process for producing a stretched, sheet-like adhesive with at least one heat-activatable polymeric thermoplastic and, if appropriate, with at least one backing, and also provides a corresponding stretched, sheet-like adhesive obtainable by the process, encompassing the following steps:
extruding the heat-activatable thermoplastic to give a thermoplastic, sheet-like adhesive, in particular to give a thermoplastic film or a thermoplastic foil,
stretching the sheet-like adhesive, in particular in machine direction, preferably by a factor of 2, based on the extruded unstretched adhesive, preferably by a factor greater than or equal to 3, particularly preferably by a factor greater than or equal to from 4 to 5, or else a higher factor, where the stretching leads to orientation of the polymer chains of the thermoplastic, in particular to an increase in the orientation of the polymer chains when comparison is preferably made with the extruded thermoplastic, and
obtaining a stretched, sheet-like adhesive.

The semicrystalline thermoplastic heat-activatable stretched, sheet-like adhesives of the invention have, by virtue of the stretching process, an increased crystalline fraction and/or an increased fraction of oriented polymers, when comparison is made with corresponding untreated adhesives, in particular merely extruded adhesives. In each individual instance, the stretching of the respective thermoplastic, and the attendant increased orientation of the polymer chains and/or increased crystallinity can be demonstrated inter alia by means of X-ray powder diffractometry or by conventional spectroscopic methods.

In one particularly preferred embodiment of the invention, the extruded thermoplastic has been stretched in machine direction by a factor of at least 4, particularly preferably a factor of 5. The factor is calculated from the ratio of the initial length of the extruded adhesive to the change in length of the stretched adhesive (Lᵢ: L₂-L₁). The stretching of the thermoplastics is subject to limits. As a function of chemical constitution and molecular weight, the extruded thermoplastic, in particular in the form of a film or of a foil, can be stretched almost as far as the threshold of tearing in machine direction.

Stretching of semicrystalline materials can generally take place in different temperature ranges with different resultant properties of the stretched materials.

The stretching of the process of the invention can therefore take place

a) at a temperature or within a temperature range above the crystallite melting range of the thermoplastic, this being followed by cooling of the sheet-like, stretched adhesive. The crystallite melting range is preferably from +85° C. to +150° C., particularly preferably around 100° C. to 120° C., with the broad melting peak typical of polymeric compounds. As an alternative, b) the stretching process can take place within the temperature range of the crystallite melting range of the thermoplastic, this being followed by cooling of the sheet-like, stretched adhesive, or c) the stretching process can take place at a temperature below the crystallite melting range of the thermoplastic. The crystallite melting range is defined in terms of the onset temperature at which the peak begins to form in the DSC process.

It is particularly preferable that the stretching process is carried out at a temperature, or within a temperature range, above the crystallite melting point, in the form of stretching of a melt. The stretching process here takes place by way of example in a slot mold, for example a slot die, and/or between slot die and application point, and/or on the chill roll, by using rollers which have a different velocity. The anisotropic orientation produced is then frozen into the material by means of the chill roll via cooling of the stretched thermoplastic in this condition. The cooling process may reach, or extend beyond, the crystallization point. The cooling process can take place in any conceivable manner, for example as mentioned via active cooling due to chill rolls, but slow cooling over a prolonged period can also be advantageous.

The stretching process is preferably carried out in the process within a temperature range which lies approximately at least 30% below the extrusion temperature; or within a range which lies below the crystallization point of at least semicrystalline thermoplastics, or below the crystallite melting point of the thermoplastic.

In an alternate particularly preferred embodiment of the invention, the stretching process takes place at a temperature which is below the extrusion temperature by at least approximately 40%, particularly preferably by at least approximately 50%, but is above 30° C. In extreme cases it is also possible to stretch the foil in machine direction at room temperature.

Because the orientation of the polymer chains is increased during the stretching process, the enthalpy of fusion is increased, in particular when said condition can in essence be fixed. A useful method of operating the process leads to an increase in the enthalpy of fusion of the stretched thermoplastic by at least about 30%, based on the extruded unstretched thermoplastic, and preferred methods of conducting the process lead to an increase in the enthalpy of fusion of the thermoplastic, after the stretching process, of at least 40% above the enthalpy of fusion of the unstretched condition. Particularly preferred methods of conducting the process bring about an increase in the enthalpy of fusion which is preferably 60% above the enthalpy of fusion of the unstretched condition. In extreme cases, it is also possible to realize values above 100%.

In the process, prior to the stretching process, it is generally possible to provide the extruded sheet-like adhesive with at least one elastic backing, and/or to provide the material after the stretching process, in the form of stretched, sheet-like adhesive, with at least one backing. It is preferable that the stretched adhesive is provided with one or more reversibly separable backings, preferably on the two adhesive sides of the sheet-like adhesive.

The invention equally provides a stretched, sheet-like adhesive with at least one heat-activatable polymeric thermoplastic, where the stretched thermoplastic in particular takes the form of a foil or film and, if appropriate, has been provided with at least one backing, where the enthalpy of fusion of the, in particular extruded and stretched, thermoplastic has been increased by at least 30%, based on the corresponding unstretched, in particular extruded, thermoplastic, and in particular the enthalpy of fusion has been increased by from at least 40% to 100%, preferably by from at least 60% to 100%, particularly preferably by from 50% to 70%, based on the corresponding unstretched thermoplastic.

It is particularly preferable here that the stretched, sheet-like adhesive is based on heat-activatable polymers or a mixture of these, where these have been selected from thermoplastics, reactive resins, and/or fillers, or a mixture of at least two of the compounds mentioned, and in particular that the stretched, sheet-like adhesive is composed thereof, and, if appropriate, has been provided with at least one backing.

Backings that can be used are conventional release foils or papers, mostly those that have been provided with a release agent, in particular in the form of release layer or release coating, for reversible adhesive bonding of the thermoplastic to the backing. The backings can encompass the conventional backings explained hereinafter.

The invention also provides a stretched, sheet-like adhesive, in particular in the form of a foil or of a film, the moisture absorption of which at 60° C. and 95% relative humidity within a period of about 24 hours, based on the corresponding, unstretched thermoplastic, in particular otherwise in essence identically treated, has been reduced by at least 10% by weight, in particular by 20% by weight, in each case with a tolerance of +/−5% by weight. Other than the stretching procedure carried out on a foil, the thermoplastics are identical in terms of their constitution, and the weight, and also the dimensions, such as film thickness and other dimensions.

In addition to the reduced moisture absorption which, without any intention to be bound to this theory, is attributed to increased crystallinity of the thermoplastic, the stretched adhesive of the invention in particular also has improved displacement-under-pressure. The displacement-under-pressure due to adhesive bonding with exposure to pressure and to heat is determined under conditions that are in essence identical for oriented sheet-like thermoplastics and for merely extruded thermoplastics.

When the displacement-under-pressure is thus determined, the stretched, sheet-like adhesives of the heat-activatable thermoplastic exhibit a reduction of from 2 to 25% in displacement-under-pressure, based on corresponding unstretched thermoplastics under conditions that are otherwise in essence identical, and in particular displacement-under-pressure has been reduced by about 10%, preferably by about 20%, in each case with a tolerance of plus/minus 5%.

Surprisingly, for the stretched, sheet-like adhesive of the invention, based on the heat-activatable thermoplastic, the increase in the number of, and/or the enlargement of, the crystalline regions within the thermoplastic is found to increase the hardness and the dimensional stability of the thermoplastic, or else of a mixture comprising the thermoplastic, for example of a blend. Said modified properties of the stretched adhesive lead to markedly improved behavior in mechanical processes, for example punching or cutting. The invention therefore provides a stretched, sheet-like adhesive of a defined shape, in particular in the shape of a punched-out section or of a shape that has been trimmed to size by way of laser-cutting processes or other processes. The sheet-like adhesive here preferably takes the form of film, foil, or coating.

The invention equally provides a stretched, sheet-like adhesive obtainable by the above process, with at least one heat-activatable polymeric thermoplastic and, if appropriate, with at least one backing, where the enthalpy of fusion of the stretched adhesive, in particular of the stretched thermoplastic, has been increased by at least 30%, based on the corresponding unstretched, extruded adhesive, in particular on the corresponding unstretched, extruded thermoplastic, where the enthalpy of fusion has in particular been increased by from at least 40% to 100%, preferably by from 60% to 100%, particularly preferably by from 50% to 70%, based on the corresponding unstretched thermoplastic.

Heat-activatable thermoplastics used for producing heat-activatable adhesives of the invention in the form of films or foils can in the first instance generally comprise any of the suitable thermoplastics which can be used for adhesive bonding when exposed to heat-activation and which can be oriented when exposed to stretching, and which can form crystalline regions.

In one very preferred embodiment, thermoplastics with a softening point above 85° C. and below 150° C. are used, where thermoplastics generally soften within a temperature range.

Examples of suitable thermoplastics are polyesters or copolyesters, polyamides or copolyamides, polyolefins, such as polyethylene (Hostalen®, Hostalen Polyethylen GmbH), and polypropylene (Vestolen P®, DSM), where the list does not claim to be exhaustive. It is also possible to use blends made of different thermoplastics.

In another embodiment, poly-a-olefins are used. Various heat-activatable poly-a-olefins are available commercially from Degussa with trademark Vestoplast™.

In order to optimize technical adhesive properties and to optimize the activation range, it is optionally possible to add tackifying resins or reactive resins. The proportion of the resins is from 2 to 30% by weight, based on the thermoplastic or, respectively, the thermoplastic blend. However, addition of the resins or other thermoplastics cannot be permitted to disrupt the capability of the thermoplastics or blends to crystallize, and in particular no excessive reduction of crystallization capability is permitted.

Additional tackifying resins that can be used are absolutely any of the previously known adhesive resins described in the literature. These resins are familiar per se to the person skilled in the art. Representative resins that may be mentioned are the pinene resins, indene resins and colophony resins, their disproportionated, hydrogenated, polymerized, and esterified derivatives and salts, the aliphatic and aromatic hydrocarbon resins, terpene resins, and terpene-phenolic resins, and also C5, C9, and also other, hydrocarbon resins. It is possible to use any desired combination of these and other resins in order to adjust the properties of the resultant adhesive mass as desired. It is generally possible to use any of the resins that are compatible (soluble) when combined with the corresponding thermoplastic, and in particular reference may be made to all of the aliphatic, aromatic, and alkylaromatic hydrocarbon resins, hydrocarbon resins based on pure monomers, hydrogenated hydrocarbon resins, functional hydrocarbon resins, and also natural resins. Express reference is made to the description of available knowledge in “Handbook of Pressure Sensitive Adhesive Technology” by Donatas Satas (van Nostrand, 1989).

In another embodiment, reactive resins are added to the thermoplastic and/or to the blend. One very preferred group of reactive resins encompasses epoxy resins. The molar mass of the epoxy resins preferably varies from 100 g/mol up to a maximum of 10 000 g/mol for polymeric epoxy resins.

The epoxy resins encompass by way of example a reaction product of bisphenol A and epichlorohydrin, a reaction product of phenol and formaldehyde (novolak resins) and epichlorohydrin and glycidyl ester, and/or a reaction product of epichlorohydrin and p-aminophenol. Preferred commercially available resins and/or starting materials for producing resins are, by way of example, but not exhaustively, Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc. from Shell Chemical, and HPT™ 1071, HPT™ 1079, likewise from Shell Chemical. Examples of aliphatic epoxy resins available commercially are vinylcyclohexane dioxides, e.g. ERL-4206, ERL-4221, ERL-4201, ERL-4289, or ERL-0400 from Union Carbide Corp. Examples of novolak resins that can be used are Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNipon Ink Chemistry, and Epicote™ 152 from Shell Chemical. Other reactive resins that can be used comprise melamine resins, e.g. Cymel™ 327 and 323 from Cytec. Other reactive resins that can be used comprise terpene-phenolic resins, e.g. NIREZ™ 2019 from Arizona Chemical. Other reactive resins that can be used are phenolic resins, e.g. YP 50 from Toto Kasei, PKHC from Union Carbide Corp. and BKR 2620 from Showa Union Gosei Corp. It is also possible to use reactive resins based on polyisocyanates, e.g. Coronate™ L from Nippon Polyurethane Ind., Desmodur™ N3300, and Mondur™ 489 from Bayer.

It is also optionally possible to add fillers, e.g. fibers, carbon black, zinc oxide, titanium dioxide, chalk, solid glass beads or hollow glass beads, microbeads made of other materials, silica, and silicates; or nucleating agents, blowing agents, compounding agents, and aids and/or antioxidants, for example in the form of primary and secondary antioxidants, or in the form of light stabilizers. The fillers are preferably added prior to or during the extrusion process, in particular added to the thermoplastic and/or to the blend. Prior to the extrusion process it is possible by way of example to carry out mixing in a twin-screw extruder.

The process for producing a stretched, sheet-like adhesive is explained hereinafter in more detail in general terms, without any restriction of the process to these embodiments. The coating process, in particular the process to produce the sheet-like adhesive, takes place from the melt. For the mixing of the resins or of the thermoplastics, it can be necessary to carry out a mixing process in advance. This mixing process can by way of example take place in a twin-screw extruder or kneader. A single-screw extruder is also generally sufficient for the coating process using pure thermoplastics, in particular the production of the sheet-like adhesive made of a pure thermoplastic. Here, the extrudate is heated in stages up to the extrusion temperature, i.e. plastified in the heating process. The temperature is selected on the basis of the melt flow index of the thermoplastic. The sheet-like, extruded adhesive, in particular the film, is formed within the extrusion die. For the coating process, in particular for the production of the sheet-like adhesive, a distinction can generally be made between the contact process and the contactless process. The thermoplastic heat-activatable sheet-like adhesive, in particular in the form of adhesive foil, can be preoriented before it leaves the die. Said process is affected, within the coating die, by the design of the die. Downstream of the exit from the die, the stretching process can take place at the exit from the die. The stretching process brings about the stretching of the sheet-like adhesive to form the stretched, sheet-like adhesive. The stretching ratio can by way of example be controlled via the width of the die gap. Stretching always occurs if the thickness of the layer of the sheet-like adhesive, in particular of the pressure-sensitive-adhesive film, is less than the width of the die gaps, and it is preferable that the stretched, sheet-like adhesive is provided with a backing material intended for coating. The stretched, sheet-like adhesive is generally applied to a backing material intended for coating, in order to form a stretched, sheet-like adhesive with backing.

The extrusion coating process preferably uses an extrusion die. The extrusion dies used can derive from one of the three following categories: T die, fishtail die, and clotheshanger die. The individual types differ in the shape of the flow channel. These shapes of extrusion die can produce orientation within the hot-melt adhesive. In the event that the intention is to produce two- or multilayer thermoplastic heat-activatable foils, it is also possible to use coextrusion dies.

For the production process, it is particularly preferable to use a clotheshanger die for coating onto a backing, in particular to form a sheet-like, preferably stretched, adhesive, and specifically in such a way that a heat-activatable stretched, sheet-like adhesive is produced in the form of foil layer on the temporary backing via a relative movement of die with respect to backing. The sheet-like adhesive, in particular the hot-melt film, is stretched by a factor of at least 3 in the process of the invention, preferably by a factor of 5.

In one preferred embodiment of the process, the extrudate is forced through a slot die and then taken off on one or more take-off rolls. The take-off rolls are also used to cool the extrudate to the desired temperature. The resultant sheet-like adhesive, in particular in the form of a foil, is then stretched longitudinally with respect to the direction of extrusion, and this leads to orientation of the polymer chains. The longitudinal stretching ratio is preferably 3:1, more preferably 4:1, most preferably greater than 5:1, and the stretched, sheet-like adhesive is obtained. The longitudinal stretching process is usefully carried out with the aid of two or more rolls running at different speeds. The stretching rolls can be heated differently. The temperature should be at least 30% below the extrusion temperature. In the event that no antiadhesive rolls are used, the temperature of the rolls should preferably be below the adhesive temperature of the heat-activatable foil.

In principle, however, it is also possible to use other stretching processes in the direction of coating. In general terms, it is clear to the person skilled in the art that stretching of the sheet-like adhesive is also possible transversely and/or obliquely with respect to the machine direction. However, this type of stretching is more complicated because of the method used to carry out the process, and is therefore less cost-effective.

After the stretching process, the heat-activatable, stretched, sheet-like adhesive, in particular in the form of foil, is provided with a backing. This can by way of example be a release foil or a release paper. To improve the anchoring of the adhesive and of the backing, it can be necessary that the heat-activatable adhesive, in particular in the form of foil, is applied electrostatically. In another embodiment, it is also possible that the heat-activatable foil is applied to a single-side-adhesive pressure-sensitive-adhesive tape. However, the adhesion of the pressure-sensitive-adhesive mass and of the sheet-like adhesive should not be very great. Furthermore, the pressure-sensitive-adhesive mass should be reversibly separable from the heat-activatable foil, not only at room temperature but also at elevated temperatures.

In another embodiment of the invention, it is also possible that the sheet-like, unstretched adhesive, in particular a heat-activatable film that has not been stretched or oriented, is applied to a release foil. The stretching then takes place longitudinally, starting from the composite of the release foil and of the heat-activatable foil. In said embodiment of the process of the invention, it is preferable and desirable that the release foil and the heat-activatable, sheet-like adhesive, in particular the heat-activatable foil, have similar thermal behavior, in order to avoid stresses. Furthermore, the release foil should have a flexible release layer, in order that this does not break up during the stretching procedure.

The design of the adhesive product is described in more detail below, without any restriction of the invention to these embodiments. The thickness of the layer of the thermoplastic heat-activatable stretched, sheet-like adhesive without temporary backing, for example in the form of a film or of a foil, is in particular from 10 to 500 μm, preferably from 25 to 250 μm. However, it is also possible to use thermoplastic heat-activatable sheet-like, or stretched sheet-like, adhesives, in particular in the form of foil, with two adhesive-bonding layers, which have been bonded by way of a primer layer/barrier layer/backing. In one preferred design, the thickness of the layer of the primer layer/barrier layer/backing is from 0.5 to 100 μm.

The backing material used, for example for the structure made of primer/barrier layer/backing can generally comprise any of the materials that are usual and familiar to the person skilled in the art for this purpose, non-restricting examples of which are: foils, in particular made of polyester, PET, PE, PP, BOPP, PVC, polyimide, polymethacrylate, PEN, PVB, PVF, or polyamide; or else nonwovens, foams, textiles, and textile foils, which likewise can be based on said materials.

Primers that can be used likewise comprise any of the polymeric or prepolymeric compounds that are suitable and familiar to the person skilled in the art, and particularly suitable materials are compounds having carboxylic acid groups. Polymers that are suitable and that are mentioned by way of example are polyurethanes, polyurethane/acrylate copolymers, copolymers or terpolymers of polyalkylenes, of polyalkyldienes, of polyacrylate esters, of polyalkyl esters, of polyvinyl esters, or polyvinylene with acrylic acid or methacrylic acid. However, it is also possible to use copolymers such as polymers based on polyethylene/acrylic acid copolymer, polyethylene/methacrylic acid copolymer, polyethylene/methacrylic acid/acrylic acid terpolymer, methyl methacrylate/acrylic acid copolymers, polybutadiene/methacrylic acid copolymers, vinyl chloride/acrylic acid copolymers, and/or a mixture of these. Polymers and/or copolymers whose use is preferred are based on polyurethanes, polyethylene/acrylic acid copolymer, and/or polyethylene/methacrylic acid copolymer. The properties of the polymers and/or copolymers can be varied via the selection of the number of carboxylic acid groups.

The primers can moreover have reactive groups, in particular other reactive groups. It is preferable that crosslinking compounds for the corresponding blends have polyfunctional groups or the compound is polyfunctional. The meaning of polyfunctional in this context is that the compounds have functionality greater than or equal to 2.

Suitable crosslinking agents encompass, here again without any claim to an exhaustive list, polyfunctional aziridines, polyfunctional carbodiimides, polyfunctional epoxies, and melamine resins. The preferred crosslinking agents are polyfunctional aziridines, e.g. trimethylpropane tris(β-(N-aziridinyl)propionate), pentaerythritol tris(β-(aziridinyl)propionate), and 2-methyl-2-ethyl-2-((3-(2-methyl-1-aziridinyl)-1-oxopropoxy)methyl) 1,3-propanediylester.

In another alternative, it is possible to use primers having hydroxyl groups or amine groups.

Binders can be added in order to adjust hardness. Liquid binders can be applied in a form that has been dissolved in water or dissolved in at least one organic solvent, or in a mixture of solvents, or in an aqueous mixture, and/or in the form of a dispersion. The materials predominantly selected for adhesive hardening are binder dispersions: non-restricting examples of these are thermosets in the form of phenolic-resin dispersions or of melamine-resin dispersions, or are elastomers in the form of dispersions of natural or synthetic rubbers, or mostly are dispersions of thermoplastics, such as acrylates, vinyl acetates, polyurethanes, styrene-butadiene systems, PVC, and the like, and also copolymers of these. It is usual to use anionic dispersions or dispersions stabilized by a nonionic method, but in particular instances it can also be advantageous to use cationic dispersions.

Temporary backing materials for the thermoplastic heat-activatable stretched, sheet-like adhesive, or the sheet-like adhesive, in particular in the form of foil or film, comprise materials that are conventional and/or familiar to the person skilled in the art, examples being foils, for example based on polyester, PET, PE, PP, BOPP, PVC, or polyimide; or nonwovens, foams, textiles, and textile foils, which can likewise be based on the polymers mentioned, other examples being release papers, based on glassine, HDPE, and/or LDPE. It is preferable here that the backing materials have been equipped with a release layer. In one particularly preferred embodiment of the invention, the release layer comprises a silicone release coating or a fluorinated release coating, and it is preferable that the release layer is composed of at least one of said coatings. In another embodiment, the thermoplastic heat-activatable stretched, sheet-like adhesive, or the sheet-like adhesive, in particular in the form of foil, can have been equipped not only with one temporary backing material but also with two temporary backing materials. This form of the double-release liner can be advantageous for producing punched-out sections.

The invention also provides the use of a stretched, sheet-like adhesive for adhesive bonding of metal-containing bodies, in particular of metals, alloys, or else of bodies comprising appropriately surface-modified metal, or of bodies based on polymeric organic compounds; in particular of plastics; or of glass bodies, and/or adhesive bonding of at least two of the bodies mentioned made of different or identical materials, in particular with application of heat during the adhesive-bonding process, preferably with additional application of pressure. It is in particular possible here that metal-containing bodies are adhesive-bonded to metals, to plastics, and/or to glass bodies, or that a plastic is adhesive-bonded to a plastic and/or to a glass body, or that the glass body is adhesive-bonded to a glass body, in particular with application of heat and, if appropriate, with application of pressure, during the adhesion process.

Explicitly, it is possible in the invention that a metal-containing body is adhesive-bonded to a plastics-based body, to a glass body, and/or to a metal-containing body, in particular with application of heat and, if appropriate, with exposure to pressure, during the adhesion process. The invention likewise provides the adhesive bonding of glass bodies, the adhesive bonding of bodies based on plastics, or else the adhesive bonding of a glass body to a body based on a plastic.

In one particularly preferred embodiment, the stretched, sheet-like adhesives are used for adhesive bonding of components, in particular of portable consumer-electronics items, preferably of components based on metal-containing bodies, on glass-containing bodies, and/or on plastics-containing bodies or on bodies coated therewith.

Descriptions in greater detail are provided below of the materials preferably intended for adhesive bonding, and also of the use or, if appropriate, the process, for adhesive bonding, but the invention is not restricted to these embodiments.

The heat-activatable stretched, sheet-like adhesives of the invention can preferably be used for the adhesive bonding of metals. In general terms, the heat-activatable, stretched adhesives can be used for the adhesive bonding of all metals, alloys, or metal-containing bodies, with or without surface-modification. It is preferable that the adhesive takes the form of a foil or of a film. Metals mentioned by way of example encompass metals or alloys comprising iron or aluminum, or magnesium or zinc. Adhesive bonding of stainless steels or other steels or of austenitic alloys is therefore possible, by way of example. In general terms, the metals can comprise conventional additives, and/or can take the form of alloys, and the adhesive of the invention can by way of example therefore be used for the adhesive bonding of iron with conventional additive systems and/or in the form of alloy.

Surface-modifications are often carried out on the metals and/or alloys, for optical reasons. By way of example, the stainless steels can be brushed or provided with a protective coating or colored coating. Other conventional surface-modifications use anodizing, chromium, chromite, or chromate. Another modification that can be used uses metallization, for example in order to passivate the surfaces. This is mostly achieved with gold or silver, which in particular are applied in the form of coating. Other surface-modifications can be based on the oxidation of the metallic surface.

It is also possible to use multilayer metals. The person skilled in the art is aware that the metal parts requiring adhesive bonding, or the metal-containing parts can in general terms be of any size and/or of any shape, and can therefore be flat, for example in the form of foils, films, or sheets, e.g. in the form of punched-out section or shaped by a laser process; or they can be three-dimensional. Nor is there any limitation in functional terms on the possible applications of the metal parts and, respectively, metal-containing parts that require adhesive bonding or that have been adhesive-bonded, and the form in which they are used can be that of decorative element, stiffening support, frame components, protective coverings, information carriers, hangers, construction element, etc.

Plastics parts that can be used and that require adhesive bonding, or parts that can be used and that are based on or comprise at least one plastic are in general terms any of the conventional plastics that are in essence solid. In the sector of consumer-electronics components, the plastics parts are usually based on extrudable plastics. Preferred components that require adhesive bonding are based on extrudable plastics such as ABS, PC, ABS/PC blends, polyamides, glassfiber-reinforced polyamides, polyvinyl chloride, polyvinylene fluoride, cellulose acetate, cycloolefin copolymers, liquid-crystal polymers (LCPs), polylactide, polyether ketones, polyetherimide, polyether sulfone, polymethylmethacrylimide, polymethylpentene, polyphenyl ether, polyphenylene sulfide, polyphthalamide, polyurethanes, polyvinyl acetate, styrene-acrylonitrile copolymers, polyacrylates and polymethacrylates, polyoxymethylene, acrylate-styrene-acrylonitrile copolymers, polyethylene, polystyrene, polypropylene, or polyester, e.g. PBT or PET, where the above list is not to be regarded as exhaustive. The person skilled in the art is aware that the adhesives of the invention can also be used for adhesive bonding of other plastics that have not been mentioned.

The components can assume any desired form that is required for the production of a component or casing for consumer-electronics items. In the simplest form, they are planar, for example taking the form of a sheet, film, or foil, another example being the shape of a punched-out section. However, 3-dimensional components are entirely conventional. The components can also cover a very wide range of functions, examples being casings or viewing windows, or stiffening elements, etc.

In another preferred aspect of the invention, the invention provides the use of a sheet-like, stretched adhesive, preferably of a punched-out section made of a stretched thermoplastic adhesive, in particular as in above embodiments, for the adhesive bonding of components, encompassing the steps of
providing a punched-out section,
positioning of the punched-out section on a component requiring adhesive bonding, in particular first component, and particularly preferably on a metal-containing component, preferably also on a plastic and/or glass-containing component,
introducing pressure and/or heat in order to increase the adhesion of the adhesive of the punched-out section on the component, where the temperature of the adhesive remains below the crystallite melting point of the thermoplastic, and obtaining a composite of the punched-out section with the component, where in particular the pressure and/or the heat is introduced by means of a heated-press ram, where the introduction of pressure preferably takes place at room temperature, in particular in order to retain in essence the orientation within the thermoplastic adhesive,
if appropriate removing a backing of the punched-out section;
if appropriate, isolating the composite and marketing it separately, for example to further processors, or
positioning of the composite on a second component, in particular a plastics component, glass component, and/or metal component, or a component of a corresponding composite material, and
introducing pressure and heat for adhesive bonding of the composite to the second component;
if appropriate cooling, and also if appropriate removing the adhesive-bonded component(s) from the molding part, if appropriate, prior to or after the cooling process.

In the invention, the composite obtained from punched-out section and from first component can be isolated and, if appropriate, marketed separately, or as an alternative the composite can be directly subjected to further use or to further processing.

The invention can also provide a process with the abovementioned steps, in particular a process in which the stretched sheet-like adhesive obtained in the process steps of the invention, if appropriate provided with at least one backing, is further processed in accordance with the use described above.

In a preferred method for the above positioning of the punched-out section on the component requiring adhesive bonding, the component has been provided with a molding part, the contact area of which is a negative of the shape of the component, and/or the molding part has guide pins for positioning a punched-out section, and/or where, for positioning of the composite on the component requiring adhesive bonding, the component has been provided with a molding part, the contact area of which is a negative of the shape of the component, and/or the composite has been fixed with use of a corresponding molding part.

It is preferable that the introduction of heat and, if appropriate, of the pressure takes place via the component, in particular a metal component, into the adhesive of the punched-out section or as an alternative via a temporary backing of the punched-out section into the adhesive on the component, in particular on a metal component, plastics component, and/or glass component. A factor that requires attention here is that the crystallite melting point of the semicrystalline thermoplastic of the adhesive is not to be exceeded during the prelamination process.

The use of the invention is explained in more detail below, but is not restricted to these embodiments.

For the prelamination process, punched-out sections of the thermoplastic heat-activatable stretched, sheet-like adhesive are usually produced, preferably in the form of a foil or of a film. These are mostly produced by means of laser cutting, or via flat-bed punching or via rotary punching. There are also many other processes known to the person skilled in the art for producing punched-out sections. In the simplest case, the punched-out section can be placed manually on the metal part, for example by means of tweezers. The size of the punched-out section here is usually in essence that of the metal part, but it can also be somewhat smaller, in order to compensate for slight tendencies toward displacement-under-pressure during the adhesive bonding process. This avoids undesirable visible oozing. As an alternative, for reasons of design, it can be necessary to use punched-out sections covering a complete area. In another embodiment, the thermoplastic heat-activatable punched-out adhesive-tape section encompassing a stretched, sheet-like adhesive can be treated with a heat source after the manual positioning process, and this can by way of example in the simplest case be achieved by using a smoothing iron. This measure makes the adhesive tacky or more tacky, and adhesion to the metal increases. Specifically in this use, it is preferable to use a punched-out section equipped with a temporary backing material.

In an alternate use, the metal part can be placed on the heat-activatable punched-out adhesive-tape section. The placing of the punched-out section is achieved by using that side of the adhesive that has no backing, and in particular that is open. It is preferable that there is still a temporary backing material on the reverse side of the punched-out section. Heat is then introduced by means of a heat source, in particular via the metal, into the thermoplastic heat-activatable sheet-like adhesive, for example in the form of an adhesive tape. This measure makes the adhesive tape tacky and causes it to adhere more strongly on the metal than on the release liner. The use of the invention is preferably based on the fact that heat is introduced via the metal component and/or via the punched-out section.

In the use of the invention, the amount of heat must be metered precisely, in particular in order in essence to retain the stretching of the thermoplastic in the adhesive during the prelamination process. The amount of heat must be properly metered for the invention, and the temperature reached should as far as possible be at most 10° C. above the temperature required to provide reliable adhesion of the adhesive, in particular of the film, on the component, preferably a metal component. The prelamination temperature should not exceed the onset temperature of the crystallite melting range, measured by means of DSC.

In one preferred design, a heated press is used to introduce the heat. The ram of the heated press can by way of example have been manufactured from aluminum, brass, or bronze, and usually has the external form or shape of the component, preferably of the metal part. The ram can therefore also be termed a molding part. The ram can moreover have design features intended to avoid any possible partial heat-damage. It is self-evident that not only pressure but also the heat, in particular required in order to adjust to a certain temperature, are introduced with maximum uniformity. The person skilled in the art is aware that pressure, temperature, and/or time have to be matched to the respective specific situation, always depending on the respective materials selected and requiring adhesive bonding. The materials here, for example metal or alloy, and the thickness of the metal, and the nature of the thermoplastic heat-activatable adhesive, in particular also in the form of a foil or of a film, affect the respective parameters, which for these reasons require variation and adaptation.

For fixing the component, preferably a metal part, on the punched-out section of the heat-activatable foil, it is preferable to use a molding part which assumes the form of the underside of the metal part. The molding part is usually a negative of the shape of the component or of a part of the component (positive shape). In order to avoid slip, stops, such as pins, can be used in the simplest case, and assume the positioning function together with defined holes, for example in the temporary backing material of the adhesive, in particular in the form of a punched-out adhesive-tape section.

After the heat-activation process, the component, preferably the metal part, can be removed with laminated punched-out adhesive-tape section from the molding part. The use described above can be manual or automated, or else converted into a process, either batchwise or continuously, for example into an automated process.

The further use of the composite obtained can be immediate or non-immediate further use, another term used being bonding process.

This further use, or the subsequent adhesive bonding process between composite and second component, where the composite encompasses the punched-out section and the first component, and in particular encompasses the composite made of metal part with punched-out section, is described below in detail via the use or the further processing as in at least one of steps 1 to 6:

1) fixing of the second component, in particular of the plastics component, glass component, or metal component, on a molding component,

2) if appropriate removing the backing of the punched-out section in the composite, in particular removing the temporary backing,

3) placing the composite, in particular encompassing a metal component with punched-out section made of heat-activatable sheet-like adhesive, such as a foil, on the second component, preferably on a plastics component, glass component, and/or metal component,

4) applying pressure and/or heat via heated-press ram,

5) if appropriate cooling in the form of reverse-cooling step,

6) obtaining an entire composite and, if appropriate, removing the adhesive-bonded components from the molding component, in particular removing the adhesive-bonded plastics components and metal components from molding component.

In general terms, the invention is not restricted to the adhesive bonding of metal components and of plastics components. As explained above, metal components can be adhesive-bonded to one another or to glass components, or else glass components can be adhesive-bonded to one another, and plastics parts can, of course, also be adhesive-bonded to one another. The person skilled in the art is aware that, for example, various alloys, glasses, or plastics can respectively have a different chemical constitution. The adhesive-bonded metals can equally have identical or different chemical constitution.

The molding component that serves to receive the components, encompassing metal components, plastics components, and/or glass components, should also have been manufactured from heat-resistant material. Examples of appropriate materials are metals or alloys of metals. However, it is also possible to use plastics or suitable composite materials, examples being fluorinated polymers or thermosets, where these simultaneously have good hardness and low deformability.

In step 4, pressure and temperature are applied. This is achieved by means of a heated ram made of a material with good thermal conductivity. Examples of conventional materials are copper, brass, bronze, or aluminum. However, it is also possible to use other alloys. The heated-press ram should moreover preferably assume the form of the upper side of the metal part, for example in the manner of a negative. Said form can be 2-dimensional or 3-dimensional. The pressure is generally applied by means of a pressure cylinder. However, it is not vital that air pressure is used for the application process. By way of example, it is also possible to use hydraulic press apparatuses or electromechanical apparatuses, such as spindles, control drives, or actuators. It can moreover be advantageous to apply pressure and heat more than once, preferably a number of times, for example in order to increase the throughput of the process via connection in series or by means of a rotation principle. In this case, it is not necessary that all of the heated-press rams are operated with identical temperature and/or identical pressure. By way of example, the temperature and/or the pressure can initially rise and, if appropriate, then in turn fall. In alternative embodiments it is moreover possible to select the contact time of the rams differently. It can moreover be advantageous, in a final step, to apply only pressure, using a ram that is not temperature-controlled, or, for example, by using a cooled ram, for example a press ram cooled to room temperature.

The invention provides a step 4 in which the thermoplastic heat-activatable stretched, sheet-like adhesive, in particular in the form of a foil, has less tendency than a corresponding unstretched adhesive to displace under pressure. In particular in relation to corresponding extruded, unstretched thermoplastics or sheet-like adhesives, under process conditions that are in other respects in essence identical, preferably being identical, examples being temperature, pressure, and/or time, the displacement of the adhesives of the invention under pressure has been reduced by from 2 to 25%, in particular by at least 10%, preferably by at least 20%.

The crystalline fractions present in the thermoplastic heat-activatable sheet-like adhesive, for example the foil, make the adhesive harder and more dimensionally stable than a corresponding untreated adhesive. The stress due to the stretching procedure is not retained, as is usual for elastic or viscoelastic materials, since the stretching of the thermoplastic, heat-activatable foil is attended by low-temperature deformation.

A punched-out section of the invention has reduced displacement-under-pressure by virtue of the orientation formed and/or frozen-in in the process of production of the thermoplastic heat-activatable sheet-like adhesive which in particular takes the form of a foil. The amount of heat introduced in the prelamination process is minimized, and this process is preferably carried out at room temperature, so that the orientation introduced in the production process, in particular via the stretching process, is in essence retained for the bonding step. In the bonding step, during the adhesive bonding process, some of the heat introduced is not only absorbed for the adhesive bonding process but instead can also be consumed for decreasing the orientation and/or for melting.

The punched-out section of the invention has reduced displacement-under-pressure by virtue of the orientation formed and frozen-in during the process of production of the thermoplastic heat-activatable stretched, sheet-like adhesive, where this orientation decreases as a result of the temperature increase during the adhesive bonding step, and this acts to counter displacement-under-pressure and thermal expansion.

The punched-out section thus retains improved dimensional stability during the adhesive bonding process. This is, in particular, the case during adhesive bonding of visible components, such as decorative elements, since otherwise adhesive-mass residues become visible at undesired locations. Another possibility when using the punched-out sections of the invention, made of the heat-activatable foils, with reduced displacement-under-pressure is that the shape of the punched-out section, in particular the area, is selected to be larger, and the geometry of the punched-out sections is also altered, since the amount of space that has to be provided for undesired escape of material is smaller. It is therefore possible to omit the interruption frequently provided in said systems between the punched-out sections, or design solutions on the actual components or adherends, where these have been provided to receive the undesired escape of adhesive.

This means that the stretched thermoplastic adhesives of the invention can then also be used for the adhesive bonding of very small components. This has hitherto been impossible with adhesive masses that exhibit excessive displacement-under-pressure, since the punched-out section was too small for said adhesive masses and it was then impossible to carry out adhesive bonding. A preferred lower limit that can be realized for the fillet width of the punched-out sections extends to a minimum of 400 μm. The upper limit depends on the design and the size of the component, and for the present invention there is no upper limit.

The displacement-under-pressure of the thermoplastic heat-activatable stretched, sheet-like adhesive, in particular in the form of a foil, is determined by way of the displacement-under-pressure test, which is described in the experimental section. Said test determines the rate of displacement-under-pressure under standard conditions.

The introduction of heat during the bonding step not only decreases the orientation (a) but also causes melting of the crystalline regions (b), and it is also possible that the water (c) present in the thermoplastic film undergoes a phase change. The water (c) can occur in the form of water vapor as a consequence of the high temperatures introduced and can then lead to blistering within the film. Said blistering generally has a marked adverse effect on the strength of the adhesive bond.

By virtue of the stretching process, the semicrystalline thermoplastic heat-activatable stretched, sheet-like adhesives of the invention have an increased crystalline fraction and/or increased content of oriented polymers, in comparison with corresponding untreated adhesives. Said increased crystallinity and/or increased orientation of the polymers is attended by reduced water inclusion. An increased amount of water is usually included in amorphous regions of the polymers. This usually occurs via adsorption from the atmosphere. The stretched adhesives have not only the improved adhesive bonding properties, for example reduced displacement-under-pressure and/or reduced blistering due to reduced water absorption, but also improved shelf life, because the reduced water absorption leads to a reduced level of degradation reactions within the polymer, for example due to hydrolysis.

The cooling step, step 5, is an optional step, which can serve to optimize adhesive bonding performance. It moreover permits simpler or quicker removal of the adhesive-bonded components. For the cooling process, a metallic press ram is generally used, the form of which is analogous to that of the heated-press ram, and which comprises no heating element, and the press ram is generally not actively temperature-controlled, and in particular operates at room temperature. As an alternative, the press ram can also be actively cooled, for example via a cooling system, by means of coolants, such as air or coolant liquids. The press ram can then actively withdraw heat from the components.

In the final step of the process, the adhesive-bonded component—the entire composite—can be removed from the molding component.

The heated-press rams for the prelamination process and the bonding process are operated within a temperature range from 60 to 300° C., depending on the heat resistance of the components, and also on the activation temperature and/or melting point of the thermoplastic heat-activatable stretched, sheet-like adhesive, in particular in the form of foil. Usual process times are from 2.5 to 15 sec per press-ram step. Another requirement can also be variation of the pressure. Very high pressures can cause greater displacement of the thermoplastic heat-activatable foil under pressure, despite the properties of the invention. Suitable pressures are in particular from 1.5 to 10 bar, calculated on the basis of the adhesive bonding area. Here again, the stability of the materials has a major effect on the respective pressure to be selected, as also does the rheology of the thermoplastic heat-activatable adhesive, in particular of the foil. The person skilled in the art is familiar with the methods for matching the respective process conditions, such as time, pressure, and/or temperature, to the respective thermoplastic adhesives and components used.

### BRIEF DESCRIPTION OF THE DRAWINGS

FIG. 1: is a diagram of the test method for checking adhesive bond strength;

FIG. 2: is a diagram of the test for measuring adhesive bond strength.

Some examples are given below for illustration of the invention, but the invention is not restricted thereto.

### EXAMPLES

I.) Test Methods:

Adhesive Bond Strength A)

Adhesive bond strength is determined by using a dynamic shear test. The adhesive bonding area is 2 cm². An Al sheet of thickness 1.5 mm and of width 2 cm is bonded to a polycarbonate (PC) sheet of width 2 cm and of thickness 3 mm by means of a thermoplastic heat-activatable foil of the invention. The thermoplastic heat-activatable foil was tested both in the stretched condition—stretched, sheet-like adhesive—and in the unstretched condition—unstretched, sheet-like adhesive. All of the specimens were subjected to further conditioning under standard conditions of temperature and humidity, for 14 d at 23° C. and 50% humidity, after the coating process and, respectively, after the stretching process.

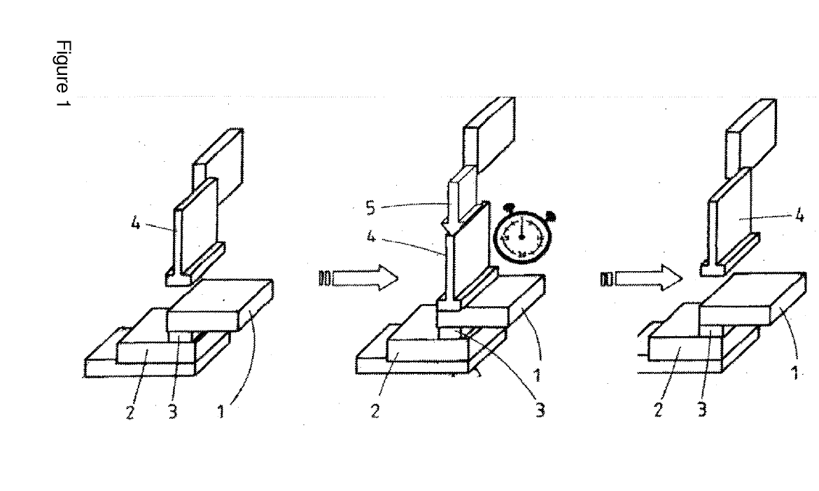

In a first step, a thermoplastic heat-activatable foil of thickness 100 μm is laminated to aluminum with the aid of a plate heated to 110° C. The release foil is then peeled away. The adhesive bonding of the test specimens is achieved in a heated press (cf. FIG. 1), where heating is achieved by way of the metal 1, i.e. the aluminum side. Heat-activation is achieved with a heated-press ram 4 heated to 150° C., at a pressure 5 of 5 bar and a press time of 5 s.

The quality of the adhesive bond, for example occurrence of blisters, can be assessed through the transparent polycarbonate after the hot adhesive bonding process.

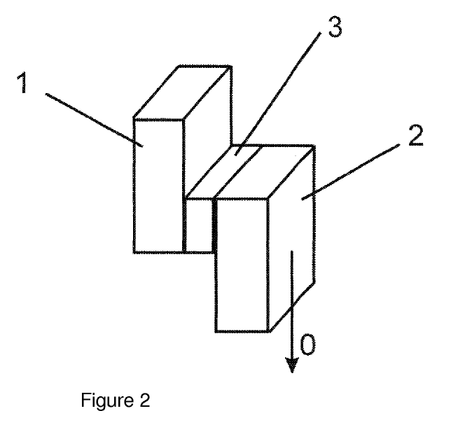

The test samples are then separated by using a tensile testing machine, shown in FIG. 2, at 10 mm/min, with use of the slowly rising force F, shown in FIG. 2 with reference symbol 0. The measurement is stated in N/mm² and is the maximum force measured for separation of the test specimens (aluminum and polycarbonate). The measurement is made at 23° C. and 50% humidity.

### Displacement-Under-Pressure B)

A circular section of the thermoplastic heat-activatable foil is punched out with a diameter of 29.5 mm. The foil has a protective cover of siliconized glassine liner both on the upper side and on the underside. This composite is then introduced into a heated press and is then subjected to pressure, using 75 N/cm² and 150° C. (heated press temperature, bilaterally heated) for 10 seconds. The application of pressure causes circular displacement of the thermoplastic. The displacement-under-pressure rate is determined as follows

$$DR = \frac{{Area}_{after} - {Area}_{initial}}{{Area}_{initial}} * 100 \%$$

where DR=displacement-under-pressure rate, Area_{after}=the area of the thermoplastic after the heated press, and Areaᵢₙᵢₜᵢₐₗ is the area of the thermoplastic prior to the heated press.

The changes in area of punched-out sections of a stretched adhesive and also of a corresponding unstretched adhesive are respectively measured in the form of displacement-under-pressure rate.

Water Absorption C)

A circular section of the thermoplastic heat-activatable foil is punched out with a diameter of 50 mm. The foil has a protective cover of siliconized glassine liner on the underside. This composite is then introduced into a chamber with controlled conditions of temperature and humidity at 60° C. and 95% humidity. The specimen is left in the chamber for 24 hours. Moisture absorption is then determined gravimetrically. Water absorption is determined by using the following formula

$$WA = \frac{Wt {.}_{after} - Wt {.}_{initial}}{Wt {.}_{initial}} * 100 \%$$

where WA=water absorption, Wt_{after}=weight of thermoplastic foil after moisture treatment, and Wtᵢₙᵢₜᵢₐₗ is equal to weight of thermoplastic foil prior to moisture treatment.

Measurement of Enthalpy of Fusion D)

Enthalpy of fusion was measured with the aid of dynamic differential calorimetry (DSC) in a Mettler DSC 822. Heating rate was 10° C./min, and the first heating curve was evaluated in the range from −100° C. to +250° C. The specimen was weighed into a perforated 40 μl aluminum crucible. The starting weight of specimen was from 10 to 15 mg. To obtain the enthalpy of fusion, the integral over the melting peak is calculated and divided by the starting weight of specimen. Enthalpy of fusion is thus stated in J/g. The percentage changes due to the stretching procedure are easily determined via measurement of the difference between the unstretched and the stretched specimen. As is usual for polymer specimens, the melting peak extends over a wide range. The range evaluated in each case was that between onset temperature and offset temperature. This is the range within which the DSC curve deviates from the base line.

### EXAMPLES

Stretching of Specimens

A strip of length 5 cm of the thermoplastic heat-activatable foil was stretched at 23° C. to a length of about 25 cm. The same procedure was carried out at 105° C., whereupon the film was immediately and suddenly cooled back to room temperature after the stretching process, in order to fix the orientation. The stretching ratio calculated from initial length and length change (L:ΔL) was therefore about 1:4. The thickness of the film after the stretching process was about 100 μm; the initial thickness of the film was about 500 μm.

### Example 1

Dynapol™ S1227 from Degussa was pressed at 140° C. to 100 μm between two layers of siliconized glassine release paper. The melting range of the copolyester is from 86° C. to 109° C.

### Example 2

Dynapol™ S1247 from Degussa was pressed at 140° C. to 100 μm between two layers of siliconized glassine release paper. The melting range of the copolyester is from 100° C. to 135° C.

### Example 3

Grilltex™ 1442 E from Ems-Grilltech was pressed at 140° C. to 100 μm between two layers of siliconized glassine release paper. The melting range of the polymer is from 93° C. to 121° C.

Results

Examples 1, 2, and 3 are examples of copolyester foils which can be used as heat-activatable foil for adhesive bonding of metal parts. The foils were first melted in a heated press and pressed to a thickness of 100 μm. The pressing procedure in the melt and the slow cooling do not produce any orientation phenomena.

The subsequent stretching procedure was carried out at 23° C. and 105° C. with sudden cooling. The specimens were then tested by test method D in the unstretched condition and in the stretched conditions. The thickness of the foils tested was in each case about 100 μm. The stretched foils were extruded at 500 μm and then stretched to 100 μm. This prevents the undesirable, visible displacement out of the adhesive joint under pressure. Table 1 shows the results.

TABLE 1

| | Test method D, | Test method D, | Test method D, |
|---|---|---|---|
| Examples | unstretched | stretched 1:4/23° C. | stretched 1:4/105° C. |
| 1 | 24.3 J/g | 43.0 J/g | 38.6 J/g |
| 2 | 8.1 J/g | 14.5 J/g | 12.7 J/g |
| 3 | 21.7 J/g | 39.4 J/g | 35.8 J/g |

Table 1 provides evidence that the selected thermoplastic heat-activatable foils can be oriented via a high level of stretching, and that the content and/or the size of crystalline domains rises. The effect is more pronounced for low-temperature stretching at 23° C. than for hot stretching (at 105° C.). The measured values provide evidence that it is possible to raise the enthalpy of fusion by almost 100%.

In a further test, displacement-under-pressure was determined for all of the examples, in order to determine the effect of the orientation process. For this, test method B was used. Table 2 shows the results.

TABLE 2

| | Test method B, | Test method B, | Test method B, |
|---|---|---|---|
| Examples | unstretched | stretched 1:4/23° C. | stretched 1:4/105° C. |
| 1 | 35.8% | 22.6% | 27.5% |
| 2 | 23.7% | 12.1% | 14.0% |
| 3 | 29.3% | 14.5% | 16.8% |

Table 2 shows that displacement-under-pressure is markedly improved by the stretching procedure.

A further intention was to test the effect of the stretching procedure on water absorption. Examples 1-3 were therefore tested by test method C. Table 3 shows the results.

TABLE 3

| | Test method C, | Test method C, | Test method C, |
|---|---|---|---|
| Examples | unstretched | stretched 1:4/23° C. | stretched 1:4/105° C. |
| 1 | 2.6% | 2.0% | 2.0% |
| 2 | 4.0% | 2.7% | 3.2% |
| 3 | 3.7% | 2.8% | 2.9% |

The results in Table 3 provide evidence that the stretching process reduces the water absorption of the copolyesters. The measured values provide evidence that the amount of water that the copolyesters can absorb is smaller, in particular by virtue of the reduced level of amorphous fractions. Samples of this type can therefore be used with markedly better effect for the adhesive bonding process, since less blistering occurs caused by moisture during the heat-activation process, and the adhesive bonding achieved is therefore more homogeneous.

Finally, the effect of the stretching process on adhesive bonding capability was also tested. For this, test method A was used. Table 4 shows the results.

TABLE 4

| | Test method A, | Test method A, | Test method A, |
|---|---|---|---|
| Examples | unstretched | stretched 1:4/23° C. | stretched 1:4/105° C. |
| 1 | 6.7 N/mm² | 6.3 N/mm² | 6.5 N/mm² |
| 2 | 8.6 N/mm² | 8.8 N/mm² | 8.5 N/mm² |
| 3 | 7.4 N/mm² | 7.0 N/mm² | 7.5 N/mm² |

Table 4 shows that there is hardly any effect on adhesive bond strength. The measured values are within the limits of accuracy of the test method. Improvements in properties can therefore be achieved via the stretching procedure while technical adhesive properties remain identical. Assessment of the number of bubbles in the adhesive bonding area showed that the number of bubbles in the adhesive bonding area was markedly greater in the unstretched examples 1 to 3 than in the comparative stretched examples likewise tested.

We claim:

1. A process for producing a stretched, sheet-like adhesive with at least one heat-activatable polymeric thermoplastic and, optionally, with at least one backing, the process comprising the steps of:
extruding the heat-activatable thermoplastic to give a thermoplastic, sheet-like adhesive,
stretching the sheet-like adhesive by a factor of 2, based on the extruded unstretched adhesive, where the stretching in particular leads to orientation of the polymer chains of the thermoplastic, and
obtaining a stretched, sheet-like adhesive.

2. The process according to claim 1, wherein the sheet-like adhesive is provided, prior to the stretching process, with at least one elastic backing, and/or the stretched, sheet-like adhesive is provided with at least one backing.

3. The process according to claim 1, wherein
a) the stretching process takes place at a temperature, or within a temperature range, above the crystallite melting range of the thermoplastic, and is followed by cooling of the sheet-like, stretched adhesive,
b) the stretching process takes place in the temperature range of the crystallite melting range of the thermoplastic and is followed by cooling of the sheet-like, stretched adhesive, or
c) the stretching process takes place at a temperature below the crystallite melting range of the thermoplastic.

4. The process according to claim 1, wherein the stretching process takes place within a temperature range which is about 30% below the extrusion temperature or below the crystallization point of an at least semicrystalline thermoplastic, or below the crystallite melting point of the thermoplastic.

5. A stretched, sheet-like adhesive with at least one heat-activatable polymeric thermoplastic and, optionally, with at least one backing, wherein an enthalpy of fusion of the extruded and stretched, thermoplastic has been increased by at least 30%, based on the corresponding unstretched extruded, thermoplastic, wherein particular the enthalpy of fusion has been increased by from at least 40% to 100%, based on the corresponding unstretched thermoplastic.

6. The adhesive according to claim 5, wherein moisture absorption at 60° C. and 95% relative humidity within a period of about 24 hours has been reduced by at least 10% by weight, based on the corresponding, unstretched, treated, thermoplastic, by 20% by weight, in each case with a tolerance of +/−5% by weight.

7. The adhesive according to claim 5, wherein the thermoplastic takes the form of a foil or a film.

8. The adhesive according to claim 5, wherein displacement of the stretched thermoplastic under pressure due to the adhesive-bonding process with exposure to pressure and to heat has been reduced by from 2 to 25%, with a tolerance of plus/minus 5%, based on the corresponding, unstretched thermoplastic under conditions that are otherwise in essence identical.

9. A stretched, sheet-like adhesive obtainable according to the process of claim 1.

10. The stretched, sheet-like adhesive according to claim 9 with at least one heat-activatable polymeric thermoplastic and, opitionally, with at least one backing, wherein an enthalpy of fusion of the stretched thermoplastic has been increased by at least 30%, based on the corresponding unstretched, extruded, thermoplastic, and the enthalpy of fusion has been increased by from at least 40% to 100%, based on the corresponding unstretched thermoplastic.

11. The stretched, sheet-like adhesive according to claim 9, wherein the stretched, sheet-like adhesive has a shape of a punched-out section.

12. A method for adhesive bonding of metal-containing bodies, of plastics, and/or of glass bodies, the method comprising the steps of:
providing a stretched, sheet-like adhesive according to claim 9; and
adhesive bonding the metal-containing bodies to metals, to plastics, and/or to glass bodies with the stretched sheet-like adhesive,
adhesive bonding the plastic to a plastic and/or to a glass body with the stretched sheet-like adhesive, or
adhesive bonding the glass body to a glass body with the stretched sheet-like adhesive,
with use of heat during the adhesive-bonding process.

13. The method according to claim 12, wherein the metal-containing bodies, of plastics, and/or of glass bodies comprise components of portable consumer-electronics items.

14. A method for adhesive bonding of components, the method comprising the steps of:
providing a punched-out section of the stretched, sheet-like adhesive according to claim 11
positioning the punched-out section on a metal-containing component requiring adhesive bonding,
supplying pressure and/or heat to increase the adhesion of the adhesive of the punched-out section on the component, where the temperature of the adhesive remains below the crystallite melting point of the thermoplastic, and obtaining a composite of the punched-out section with the component,
optionally, removing a backing of the punched-out section.

15. The method according to claim 14, further comprising:
positioning the composite on a second component selected from the group consisting a plastics component, glass component, and metal component:
supplying pressure and heat for adhesive bonding of the composite to the second component; and
optionally, cooling.

16. The method according to claim 14, wherein, for positioning of the punched-out section on the component requiring adhesive bonding, the component has been provided with a molding part, and/or the molding part has guide pins for positioning a punched-out section, and/or wherein, for positioning of the composite on the second component requiring adhesive bonding, the component has been provided with a molding part, and/or the composite has been provided with a molding part.

17. The process according to claim 1, wherein the thermoplastic, sheet-like adhesive is a thermoplastic film or a thermoplastic foil.

18. The process according to claim 1, wherein the sheet-like adhesive is stretched in the machine direction.

19. The process according to claim 1, wherein the sheet-like adhesive is strectched by a factor greater than or equal to from 4 to 5 or a higher factor.

20. The stretched, sheet-like adhesive according to claim 5, wherein the enthalpy of fusion has been increased by from at least 60% to 100%
